(19) United States
(12) Patent Application Publication
(10) Pub. No.: US 2013/0045106 A1
(43) Pub. Date: Feb. 21, 2013

(54) ANGLED TRENCH DIFFUSER

(71) Applicant: Benjamin Paul Lacy, Greer, SC (US)

(72) Inventor: Benjamin Paul Lacy, Greer, SC (US)

(73) Assignee: GENERAL ELECTRIC COMPANY, Schenectady, NY (US)

(21) Appl. No.: 13/209,711

(22) Filed: Aug. 15, 2011

(51) Int. Cl. F01D 5/14; B32B 3/24; B23P 17/00; B29C 35/08

(52) U.S. Cl. 416/237; 264/400; 428/137; 29/558

(57) ABSTRACT

An article is disclosed that includes a substrate having a first surface and a second surface and a coating disposed on the second surface. In addition, the article includes an angled trench at least partially defined in the coating. The angled trench may include a bottom surface, a first sidewall and a second sidewall disposed downstream of the first sidewall. The first and second sidewalls may extend from the bottom surface at an angle of less than about 60 degrees. Moreover, the article may include a plurality of holes defined between the first surface and the bottom surface.

This invention was made with Government support under Contract No. DE-FC26-05NT42643 awarded by the Department of Energy. The Government may have certain rights in this invention.

### FIELD OF THE INVENTION

The present subject matter relates generally to an angled trench diffuser for an article and, more particularly, to an angled trench and corresponding diffuser holes for cooling an airfoil of a gas turbine component.

### BACKGROUND OF THE INVENTION

In a gas turbine, hot gases of combustion flow from an annular array of combustors through a transition piece for flow along an annular hot gas path. Turbine stages are typically disposed along the hot gas path such that the hot gases of combustion flow from the transition piece through first-stage nozzles and buckets and through the nozzles and buckets of follow-on turbine stages. The turbine buckets may be secured to a plurality of turbine wheels comprising the turbine rotor, with each turbine wheel being mounted to the rotor shaft for rotation therewith.

A turbine bucket generally includes an airfoil extending radially outwardly from a substantially planar platform and a hollow shank portion extending radially inwardly from the platform. The shank portion may include a dovetail or other means to secure the bucket to a turbine wheel of the turbine rotor. In general, during operation of a gas turbine, the hot gases of combustion flowing from the combustors are generally directed over and around the airfoil of the turbine bucket. Thus, to protect the part from high temperatures, the airfoil typically includes an airfoil cooling circuit configured to supply a cooling medium, such as air, throughout the airfoil in order to reduce the temperature differential between the pressure and suction sides of the airfoil. In addition, the exterior surfaces of the airfoil may be coated (e.g., with a thermal barrier coating (“TBC”) system) to provide such surfaces oxidation/corrosion and/or thermal protection. Theses coatings are typically used in conjunction with a cooling scheme or arrangement for supplying air to the pressure side surface and/or the suction side surface of the airfoil.

Conventionally, the surfaces of bucket airfoils are cooled using a series of film holes defined through such surfaces. In particular, the film holes are typically drilled straight through the airfoil surface(s) and into the airfoil cooling circuit to permit the cooling medium flowing through the cooling circuit to be supplied to the airfoil surface. However, it has been found that these film holes often provide for less than optimal cooling of the airfoil's surface. Specifically, since the film holes are drilled straight into the airfoil, the exit angle of the cooling medium expelled from the holes is relatively high, thereby negatively impacting flow attachment of the cooling medium against the surface of the airfoil. To address such flow attachment issues, various design modifications to the film holes have been proposed, such as by forming advanced-shaped film holes within the airfoil (e.g., chevron-shaped holes) or by forming complex-shaped outlets for the film holes. However, these design modifications are often very difficult to manufacture and, thus, significantly increase the overall costs of producing a turbine bucket.

Accordingly, a cooling arrangement that may be easily manufactured and that provides sufficient cooling to the surfaces of an airfoil would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses an article including a substrate having a first surface and a second surface and a coating disposed on the second surface. In addition, the article includes an angled trench at least partially defined in the coating. The angled trench may include a bottom surface, a first sidewall and a second sidewall disposed downstream of the first sidewall. The first and second sidewalls may extend from the bottom surface at an angle of less than about 60 degrees. Moreover, the article may include a plurality of holes defined between the first surface and the bottom surface.

In another aspect, the present subject matter discloses a turbine component including an airfoil having a base and a tip disposed opposite the base. The airfoil may be formed from a substrate having a first surface and a second surface. In addition, the turbine component may include a thermal barrier coating system disposed on the second surface and an angled trench at least partially defined in the thermal barrier coating system so as to extend lengthwise at least partially between the base and the tip. The angled trench may include a bottom surface, a first sidewall and a second sidewall disposed downstream of the first sidewall. The first and second sidewalls may extend from the bottom surface at an angle of less than about 60 degrees. Moreover, the article may include a plurality of holes defined between the first surface and the bottom surface.

In a further aspect, the present subject matter discloses a method for making an article formed from a substrate having a first surface, a second surface and a coating disposed on the second surface. The method may include removing a portion of the coating to form an angled trench, wherein the angled trench has a bottom surface and at least one sidewall extending from the bottom surface at an angle of less than about 60 degrees and forming a plurality of holes extending from the bottom surface to the first surface of the substrate.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a turbine bucket having an angled trench and diffuser holes defined therein in accordance with aspects of the present subject matter;

FIG. 2 illustrates a cross-sectional view of the turbine bucket shown in FIG. 1 taken along line 2-2;

FIG. 3 illustrates a cross-sectional view of a portion of the airfoil of the turbine bucket shown in FIG. 2, particularly illustrating a close-up, cross-sectional view of the angled trench and the diffuser hole shown in FIG. 2;

FIG. 4 illustrates a pressure side view of a portion of the airfoil of the turbine bucket shown in FIG. 1, particularly illustrating a close-up, top view of the angled trench and several of the diffuser holes shown in FIG. 1;

FIG. 5 illustrates a flow diagram of one embodiment of a method for making a component and/or article in accordance with aspects of the present subject matter;

FIG. 6 illustrates a perspective view of one embodiment of a shaped electrode that may be utilized to form the diffuser holes of present subject matter; and

FIG. 7 illustrates a perspective view of one embodiment of an electrode comb that may be utilized to form the angled trench and the diffuser holes of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present subject matter is generally directed to an angled trench diffuser formed in an article having a substrate and a coating applied to an outer surface of the substrate. In particular, the present subject matter discloses an angled trench diffuser formed in a turbine component having a substrate and a thermal barrier coating (“TBC”) system applied thereon. In several embodiments, the angled trench diffuser may include an angled trench formed within the TBC system and a plurality of diffuser holes extending from the angled trench to an inner surface of the substrate. For example, in one embodiment, the angled trench may be defined in the pressure side surface and/or the suction side surface of an airfoil of a turbine component (e.g., a turbine bucket and/or a turbine nozzle). In such an embodiment, the diffuser holes may be formed within the airfoil so as to extend between the angled trench and an airfoil cooling circuit of the airfoil such that the cooling medium flowing through the airfoil cooling circuit may be directed through the diffuser holes and into the angled trench to provide film cooling to the surface of the airfoil. The use of such diffuser holes together with the angled trench may maximize spreading of the film of cooling medium across the airfoil surface, thereby enhancing the film cooling effectiveness, reducing cooling requirements and/or increasing component life and/or temperature capability.

In general, the angled trench and diffuser holes of the present subject matter will be described herein with reference to a turbine bucket of a gas turbine. However, it should be readily appreciated by those of ordinary skill in the art that the angled trench and diffuser holes may generally be defined in any other suitable turbine component (e.g., turbine nozzles, stator vanes, compressor blades, combustion liner, transition pieces, exhaust nozzles and/or the like). Additionally, it should be appreciated that application of the present subject matter need not be limited to turbine components. Specifically, the angled trench and diffuser holes may generally be formed in any suitable article through which a medium (e.g., water, steam, air and/or any other suitable fluid) is directed for cooling a surface of the article and/or for maintaining the temperature of a surface of the article.

Moreover, it should be readily appreciated that, although the angled trench and diffuser holes will generally be described herein as being defined in a component and/or article having a TBC system, the angled trench and diffuser holes may generally be defined in a component and/or article having any suitable coating and/or coating system applied thereon. Thus, in several embodiments of the present subject matter, the angled trench may be formed within a TBC system or any other suitable coating and/or coating system known in the art.

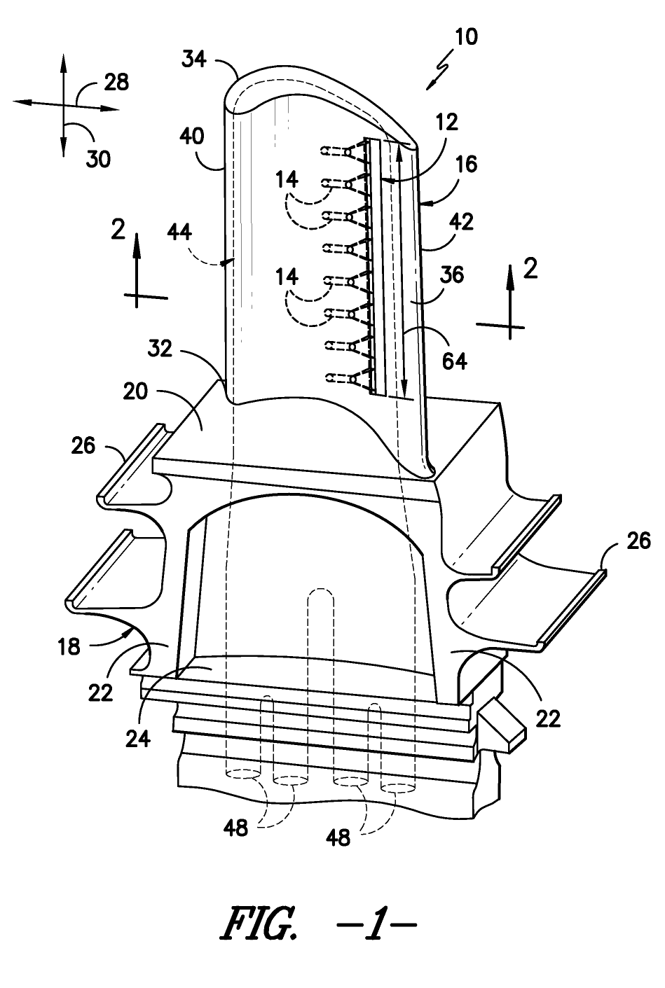

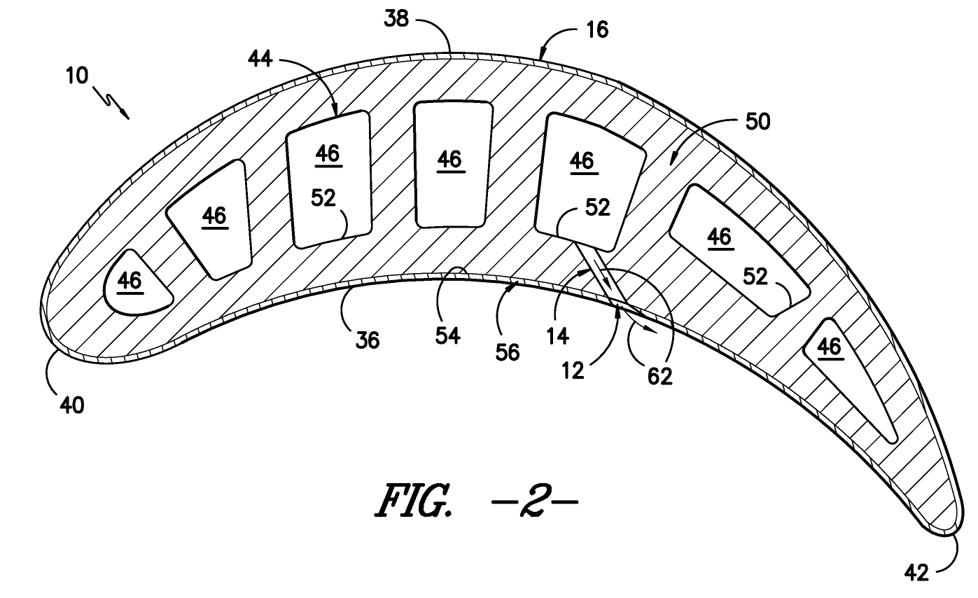

Referring now to the drawings, FIGS. 1 and 2 illustrate one embodiment of a turbine bucket 10 having an angled trench 12 and a plurality of diffuser holes 14 defined therein in accordance with aspect of the present subject matter. In particular, FIG. 1 illustrates a perspective view of the turbine bucket 10. FIG. 2 illustrates a cross-sectional view of a portion of an airfoil 16 of the turbine bucket 10 shown in FIG. 1 taken along line 2-2, particularly illustrating a cross-sectional view of the angled trench 12 and one of the diffuser holes 14 shown in FIG. 1.

As shown, the turbine bucket 10 generally includes a shank portion 18 and an airfoil 16 extending from a substantially planar platform 20. The platform 20 generally serves as the radially inward boundary for the hot gases of combustion flowing through a turbine section of a gas turbine (not shown). The shank portion 18 of the bucket 10 may generally be configured to extend radially inwardly from the platform 20 and may include sides 22, a hollow cavity 24 partially defined by the sides 22 and one or more angel wings 26 extending in an axial direction (indicated by arrow 28) from each side 22. The shank portion 18 may also include a root structure (not illustrated), such as a dovetail, configured to secure the bucket 10 to a rotor disk of a gas turbine (not shown).

The airfoil 16 may generally extend outwardly in a radial direction (indicated by arrow 30) from the platform 20 and may include an airfoil base 32 disposed at the platform 20 and an airfoil tip 34 disposed opposite the airfoil base 32. Thus, the airfoil tip 34 may generally define the radially outermost portion of the turbine bucket 10. The airfoil 16 may also include a pressure side surface 36 and a suction side surface 38 (FIG. 2) extending between a leading edge 40 and a trailing edge 42. The pressure side surface 36 may generally comprise an aerodynamic, concave outer surface of the airfoil 16. Similarly, the suction side 48 may generally define an aerodynamic, convex outer surface of the airfoil 16.

Additionally, the turbine bucket 10 may also include an airfoil cooling circuit 44 extending radially outwardly from the shank portion 18 for flowing a medium, such as a cooling medium (e.g., air, water, steam or any other suitable fluid), throughout the airfoil 16. In general, it should be appreciated that the airfoil circuit 44 may have any suitable configuration known in the art. For example, in several embodiments, the airfoil circuit 44 may include a plurality of channels 46 (FIG. 2) extending radially outwardly from one or more supply passages 48 to an area of the airfoil 16 generally adjacent the airfoil tip 34. Specifically, as shown in FIG. 2, the airfoil circuit 44 includes seven radially extending channels 46 configured to flow the medium supplied from the supply passages 48 throughout the airfoil 16. However, one of ordinary skill in the art should appreciate that the airfoil circuit 44 may include any number of channels 46.

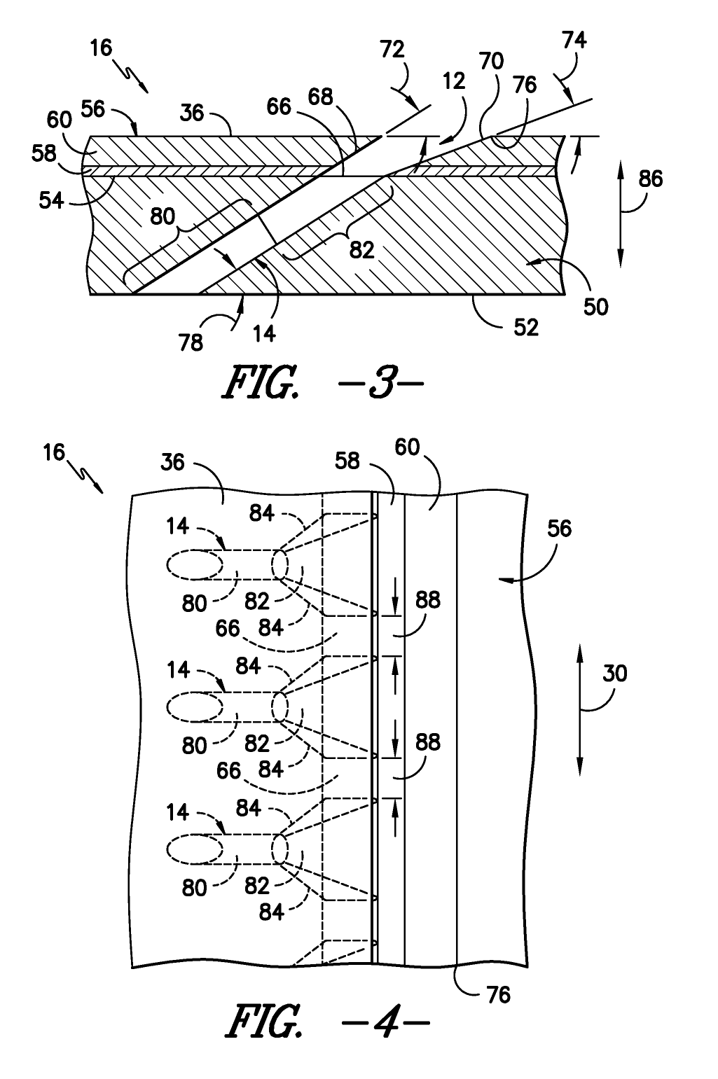

Moreover, as particularly shown in FIG. 2, the airfoil 16 of the turbine bucket 10 may generally be formed from a substrate 50 having a first or inner surface 52 and a second or outer surface 54. The inner surface 52 may also be referred to as the “cool” surface while the outer surface 54 may be referred to as the “hot” surface, since the outer surface 54 is generally exposed to relatively higher temperatures than the inner surface 52 during operation of a gas turbine (not shown). For example, as shown in the illustrated embodiment, the inner surface 52 of the substrate 50 may generally define all or part of the channels 46 of the airfoil circuit 44. As such, the medium flowing through the channels 46 may provide direct cooling for such surface 52. Additionally, to protect the outer surface 54 from corrosion/oxidation and/or to increase the operating temperature capability of the substrate 50, a thermal barrier coating (TBC) system 56 may be disposed on the outer surface 54 of the substrate 50. For example, as will be described below with reference to FIG. 3, the TBC system 56 may include a bond layer 58 and a thermal barrier layer 50 disposed on the outer surface 54 of the substrate 50.

It should be appreciated that the substrate 50 may generally comprise any suitable material capable of withstanding the desired operating conditions of the component and/or article being formed by the substrate 50. For example, in embodiments in which the substrate 50 forms part of a turbine component (e.g., the turbine bucket 10) suitable materials may include, but are not limited to, ceramics and metallic materials, such as steel, refractory metals, nickel-based superalloys, cobalt-based superalloys, iron-based superalloys and/or the like.

Referring still to FIGS. 1 and 2, as indicated above, the turbine bucket 10 may also include an angled trench 12 and a plurality of holes 14 (e.g., diffuser holes 14) defined in the airfoil 16. In general, the diffuser holes 14 may be configured to supply a portion of the medium (indicated by arrows 62) flowing through the airfoil circuit 44 to the angled trench 12 for cooling the pressure side surface 36 and/or the suction side surface 38 of the airfoil 16. Thus, in several embodiments, each of the diffuser holes 14 may be in flow communication with a portion of the airfoil circuit 44 at one end and may be in flow communication with the angled trench 12 at the other end. For example, as shown in the illustrated embodiment, the diffuser holes 14 may extend within the airfoil 106 from the inner surface 52 of the substrate 50 (e.g., from one of the channels 46 of the airfoil circuit 44) to the angled trench 12 defined in the pressure side surface 36 of the airfoil 16 (e.g., the TBC system 56 of the airfoil 16). As such, the medium flowing through the airfoil circuit 44 may be directed into the angled trench 12 through each of the diffuser holes 14 and may be subsequently expelled from the angled trench 12 onto the pressure side surface 36 of the airfoil 16 to provide a means for film cooling such surface 36.

It should be appreciated that the angled trench 12 may generally be defined in the airfoil 16 so as to define any suitable radial length 64 that allows each of the diffuser holes 14 to be in flow communication with the trench 12. For example, as particularly shown in FIG. 1, the diffuser holes 14 may be spaced apart radially along the airfoil 16 in a row extending generally from the airfoil base 32 to the airfoil tip 34. Thus, the angled trench 12 may be configured to define a radial length 64 extending generally from the airfoil base 32 to the airfoil tip 34. However, in other embodiments, the angled trench 12 may be configured to extend radially only partially between the airfoil base 32 to the airfoil tip 34.

It should also be appreciated that the angled trench 12 and/or the diffuser holes 14 may generally be defined at any suitable location within and/or around the outer perimeter of the airfoil 16. For example, in several embodiments of the present subject matter, the angled trench 12 may be defined on the pressure side 36 or the suction side 38 of the airfoil 16 at any suitable location between the leading and trailing edges 40, 42, with the diffuser holes 14 being defined in the airfoil 16 at a suitable location for directing the medium flowing through the airfoil circuit 44 into the angled trench 16. Similarly, it should be readily appreciated that the turbine bucket 10 may include more than one angled trench 12 and corresponding set of diffuser holes 14. For example, in one embodiment, multiple trenches 12 may be defined on the pressure side 36 or suction side 38 of the airfoil 16. Alternatively, one or more trenches 12 may be defined on both the pressure and suction sides 36, 38 of the airfoil 16.

Referring now to FIGS. 3 and 4, differing views of the angled trench 12 and diffuser holes 14 shown in FIGS. 1 and 2 are illustrated in accordance with aspects of the present subject matter. In particular, FIG. 3 illustrates a cross-sectional view of a portion of airfoil 16 shown in FIG. 2, particularly illustrating a close-up, cross-sectional view of the angled trench 12 and one of the diffuser holes 14. Additionally, FIG. 4 illustrates a pressure side view of a portion of the airfoil 16 shown in FIG. 1, particularly illustrating a close-up view of a portion of the angled trench 12 and several of the diffuser holes 14.

As indicated above, the substrate 50 of the airfoil 16 may generally include an inner surface 52 defining all or part of the channels 46 of the airfoil circuit 44 (FIG. 2) and an outer surface 54 having a TBC system 56 applied thereon. As shown in FIG. 3, the TBC system 56 may generally include a bond layer 58 covering the outer surface 54 of the substrate 50 and a thermal barrier layer 60 disposed over the bond layer 58. As is generally understood, the bond layer 58 may be formed from an oxidation resistant metallic material designed to inhibit oxidation and/or corrosion of the underlying substrate 50. For instance, in several embodiments, the bond layer 58 may be formed from a material comprising “MCrAlY,” where “M” represents iron, nickel or cobalt, or from an aluminide or noble metal aluminide material (e.g., platinum aluminide). Similarly, the thermal barrier layer 60 may be formed from a temperature resistant material in order to increase the operating temperature capability of the substrate 50. For example, in several embodiments, the thermal barrier layer 60 may be formed from various known ceramic materials, such as zirconia partially or fully stabilized by yttrium oxide, magnesium oxide or other noble metal oxides.

It should be appreciated by those of ordinary skill in the art that the bond layer 58 and the thermal barrier layer 60 may be applied onto the outer surface 54 of the substrate 50 using any suitable process known in the art including, but not limited to, pack diffusion processes, physical vapor deposition processes, chemical vapor deposition processes and/or thermal spraying processes. It should also be appreciated that the TBC system 56 need not include multiple layers. For instance, in one embodiment, the TBC system 56 may simply comprise a thermal barrier layer 60 applied directly to the outer surface 54 of the substrate 50.

In general, the angled trench 12 of the present subject matter may be defined within the TBC system 56. In several embodiments, the angled trench 12 may be formed entirely within the TBC system 56. For example, as shown in FIG. 3, in one embodiment, the angled trench 12 may be formed in the TBC system 56 such that a bottom surface 66 of the angled trench 12 extends parallel to and is defined by the outer surface 54 of the substrate 50. However, in another embodiment, the angled trench 12 may be defined through only a portion of the TBC system 56, such as by forming the angled trench 12 within the TBC system 56 such that the bottom surface 66 is defined entirely by and/or in one of the layers 58, 60 of TBC system 56. Alternatively, the angled trench 12 may only be formed partially within the TBC system 56. For example, in one embodiment, the angled trench 12 may be formed entirely through the TBC system 56 and into the substrate 50 such that at least a portion of the bottom surface 66 is defined below the outer surface 54 of the substrate 50.

As shown in FIG. 3, in addition to the bottom surface 66, the angled trench 12 may also include a first sidewall 68 and a second sidewall 70 disposed downstream of the first sidewall 68. As used herein, the term “downstream” refers to the direction in which the local flow is traveling. In several embodiments, the first sidewall 68 may generally extend outwardly from the bottom surface 66 such that a first angle 72 is defined between the first sidewall 68 and bottom surface 66. Similarly, the second sidewall 70 may generally extend outwardly from the bottom surface 66 such that a second angle 74 is defined between the second sidewall 70 and the bottom surface 66.

In general, the first and second angles 72, 74 may correspond to any suitable angle that permits the angled trench 12 to function as described herein. For example, in several embodiments, the first and second angles 72, 74 may correspond to an angle equal to less than about 60 degrees, such as less than about 45 degrees or less than about 40 degrees. Additionally, it should be appreciated that the first and second angles 72, 74 may be equal or may differ from one another. For instance, it may be desirable for second sidewall 70 to define a shallower angle than the first sidewall 68 to enhance flow attachment of the medium against the surface of the airfoil 16 (e.g., the pressure side surface 36) as it exits the angled trench 12 at a top end 76 of the second sidewall 70. Thus, as shown in the illustrated embodiment, the second angle 74 may be smaller than the first angle 72 such that the transition at the top end 76 between the second sidewall 70 and the surface of the airfoil 16 is relatively smooth, thereby encouraging the film of medium to layover onto the airfoil surface. For example, in a particular embodiment of the present subject matter, the first angle 72 may be equal to an angle ranging from about 15 degrees to about 45 degrees, such as from about 20 degrees to about 40 degrees or from about 20 degrees to about 30 degrees and all other subranges therebetween, and the second angle 74 may be equal to an angle ranging from about 5 degrees to about 35 degrees, such as from about 10 degrees to about 30 degrees or form about 10 degrees to about 20 degrees and all other subranges therebetween.

Referring still to FIGS. 3 and 4, as indicated above, a plurality of radially spaced diffuser holes 14 may also be defined within the airfoil 16 such that the medium supplied through the airfoil circuit 44 may be directed through the diffuser holes 14 and into the angled trench 12. Thus, as shown in FIG. 3, each diffuser hole 12 may generally be defined in the airfoil 16 so as to extend between the inner surface 52 of the substrate 50 and the bottom surface 66 of the angled trench 12. Additionally, in several embodiments, each diffuser hole 15 may have an angled orientation between the inner surface 52 of the substrate 50 and the bottom surface 66 of the angled trench 12. For instance, the diffuser holes 14 may be inclined at a diffuser angle 78 of less than about 60 degrees, such as less than about 45 degrees or less than about 40 degrees. Moreover, as shown in FIG. 3, in one embodiment, the angle 78 of the diffuser holes 16 may be substantially equal to the first angle 72 of the first sidewall 68. However, in alternative embodiments, the angle 78 may be equal to the second angle 74 of the second sidewall 70 or may differ from both the first and second angles 72, 74. In addition, straight non-diffusing holes of any suitable, relatively constant cross-section may be used.

Moreover, as particularly shown in FIG. 4, each diffuser hole 14 may generally include a metering portion 80 and a diffusing portion 82. In general, the metering portion 80 of each diffuser hole 14 may comprise a substantially straight passage extending between the inner surface 52 of the substrate 50 and the diffusing portion 82. Thus, in the illustrated embodiment, the medium supplied through the airfoil circuit 44 (FIG. 2) may enter the metering portion 80 of each diffuser hole 14 at the inner surface 52 and flow through such portion 80 to the diffusing portion 82 of each diffuser hole 14. In addition, the metering portion 80 may generally define a substantially constant cross-sectional area. For example, in the illustrated embodiment, the metering portion 80 defines a substantially constant circular cross-sectional shape between the inner surface 52 and the diffusing portion 82. However, in alternative embodiments, the metering portion 80 may have any other suitable cross-sectional shape, such as by defining a rectangular or oval cross-sectional shape.

The diffusing portion 82 of each diffuser hole 14 may generally be configured to diverge outwardly from the metering portion 80 towards the bottom surface 66 of the angled trench 12. For example, as shown in FIG. 4, the diffusing portion 82 may have a generally rectangular cross-sectional shape with sidewalls 84 configured to diverge outwardly in a radial or longitudinal direction of the angled trench 12 (indicated by arrows 30 in FIGS. 1 and 4) between the metering portion 80 and the bottom surface 66. As a result, the medium directed through the metering portion 80 and into the diffusing portion 82 may expand outwardly as it flows from the diffuser holes 14 to the angled trench 12. In particular, the diverging sidewalls 84 may permit the medium to expand in the radial or longitudinal direction within the diffusing portion 82, thereby reducing the velocity and increasing the pressure of the medium. Such reduced velocity may generally enhance flow attachment of the medium against the second sidewall 70 of the angled trench 12 and, thus, may, in turn, enhance flow attachment against the surface of the airfoil 16 (e.g., the pressure side surface 36) as the medium exits at the angled trench 12 at the top end 76 of the second sidewall 70.

In alternative embodiments, it should be appreciated that the diffusing portion 82 of each diffuser hole 12 may have any other suitable cross-sectional shape. For example, instead of a generally rectangular cross-sectional shape, the diffusing portion 82 may define a generally circular or oval cross-sectional shape. It should also be appreciated that the diffusing portion 82 of each diffuser hole 14 may be configured to diverge outwardly in any direction and, thus, need not be limited to diverging only in the radial or longitudinal direction. For example, in another embodiment of the present subject matter, the diffusing portion 82 of each diffuser hole 14 may include sidewalls diverging outwardly in a direction transverse to the longitudinal direction (indicated by arrow 86 in FIG. 3). Alternatively, the diffusing portion 82 may be configured to diverge outwardly in both the longitudinal and transverse directions.

Moreover, as shown in FIG. 4, in one embodiment, the diffuser holes 14 may be spaced apart radially from one another such that a gap 88 is defined between the diverging sidewalls 84 of adjacent diffuser holes 14 at the intersection of such sidewalls 84 and the bottom surface 66 of the angled trench 12. However, in alternative embodiments, the diffuser holes 14 may be defined in the airfoil 16 such that the sidewalls 84 of adjacent diffuser holes 14 intersect one another. In such embodiments, the bottom surface 66 of the angled trench 12 may generally be defined at the point at which the sidewalls 84 intersect.

It should be appreciated that, although the holes 14 are described herein as “diffuser holes,” the holes 14 need not include a diffusing portion 82. Specifically, in alternative embodiments, the holes 14 may simply comprise straight, metering holes that do not diffuse or diverge in any direction.

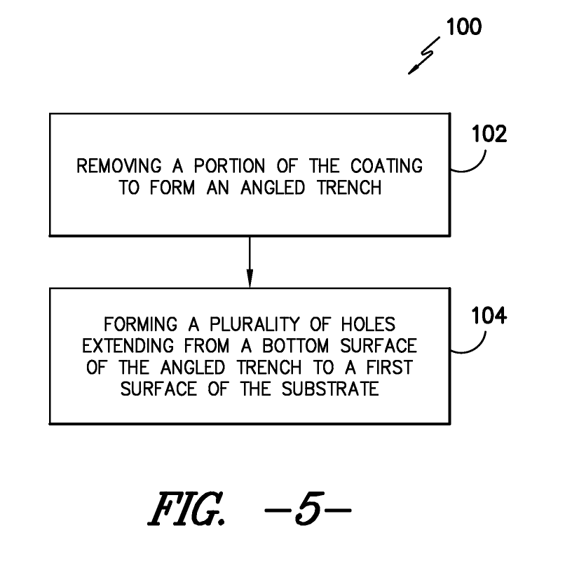

Referring now to FIG. 5, there is illustrated a flow diagram of one embodiment of a method 100 for making a turbine bucket 10 or any other article formed from a substrate 50 having a coating (e.g., a TBC system 56) disposed thereon. As shown, the method 100 generally includes removing a portion of the coating to form an angled trench 102 and forming a plurality of holes extending between a bottom surface of the angled trench and a first or inner surface of the substrate 104. It should be appreciated that, although the elements 102, 104 of the disclosed method 100 are illustrated in a particular order in FIG. 5, the elements 102, 104 may generally be performed in any sequence and/or order consistent with the disclosure provided herein.

In general, angled trench 12 of the present subject matter may be formed by removing portions of the TBC system 56 or other coating using various known machining processes. For example, in one embodiment, a laser machining process may be used to form the angled trench 12 within the TBC system 56. In another embodiment, the angled trench 12 may be formed within TBC system 56 using an electrical discharge machining (“EDM”) process, a water jet machining process (e.g., by using an abrasive water jet process) and/or a milling process. Alternatively, any other suitable machining process known in the art for removing selected portions of material from an object may be utilized to form the angled trench 12.

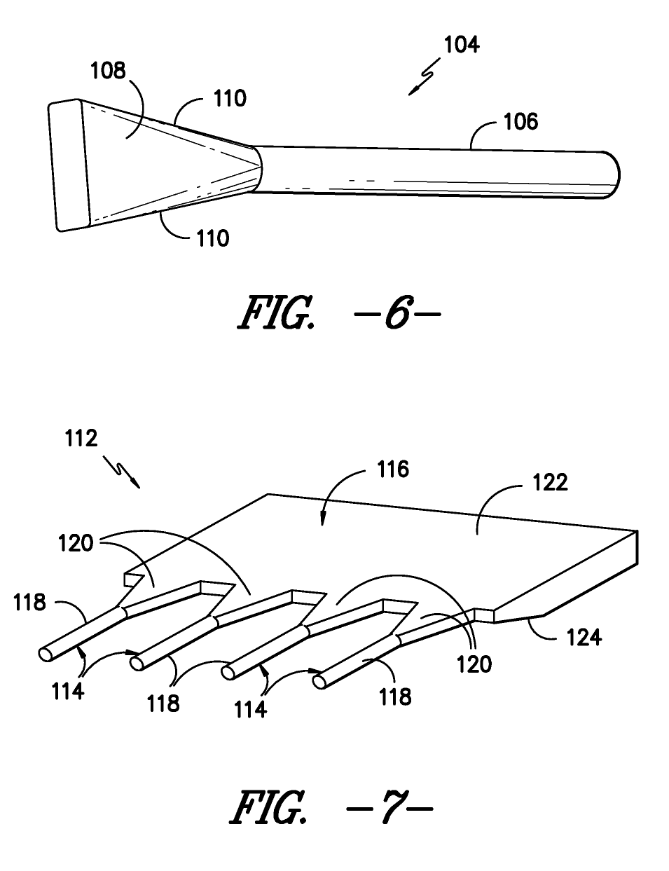

Similarly, the disclosed diffuser holes 14 may be formed using various known machining processes, such as by using a laser machining process, an EDM process, a water jet machining process, a milling process and/or any other suitable machining process. Additionally, in one embodiment, the metering portion 80 of each diffuser hole 14 may be formed in a separate manufacturing step from the diffusing portion 82 of each diffuser hole 14. For example, the metering portion 80 may be initially formed within the substrate 50 with the diffusing portion 82 being subsequently machined therein or vice versa. Alternatively, the metering portion 80 and the diffusing portion 82 may be formed together in a single manufacturing step. For instance, FIG. 6 illustrates one embodiment of a shaped electrode 104 that may be utilized in an EDM process to simultaneously form both the metering portion 80 and the diffusing portion 82 of one of the diffuser holes 14. As shown, the shaped electrode 104 includes a straight section 106 having a generally constant cross-sectional area for forming the metering portion 80 of each diffuser hole 14. In addition, the shaped electrode 104 includes a diverging section 108 having diverging sidewalls 110 generally corresponding to the sidewalls 84 of the diffusing portion 82. Thus, as the shaped electrode 104 is moved within the substrate 50, portions of the substrate 50 may be eroded away by the straight section 106 and the diverging section 108 to define the desired shape of the metering portion 80 and the diffusing portion 82 of each diffuser hole 14.

Additionally, it should be appreciated that, in one embodiment, all the diffuser holes 14 may be formed simultaneously after the angled trench 12 has been formed or the angled trench 12 and the diffuser holes 14 may be formed together in a single manufacturing step. For example, FIG. 7 illustrates one embodiment of an electrode comb 112 that may be utilized in an EDM process to simultaneously form just the diffuser holes 14 or both the angled trench 12 and the diffuser holes 14. As shown, the electrode comb 112 includes a plurality projections 114 extending from a comb base 116. Each projection 114 may generally be designed to form one of the diffuser holes 14. As such, each projection 114 may generally be configured the same as or similar to the shaped electrode 104 described above with reference to FIG. 6, such as by having a straight section 118 for forming the metering portion 80 of each diffuser hole 14 and a diverging section 120 for forming the diffusing portion 82 of each diffuser hole 14. Additionally, a portion of the comb base 116 may generally be designed to form the angled trench 12. For instance, the comb base 116 may include a first side 122 having an angular orientation corresponding to the angular orientation of the first sidewall 68 of the angled trench 12 and a second side 124 having an angular orientation corresponding to the angular orientation of the second sidewall 70 of the angled trench 12. Accordingly, as the electrode comb 112 is moved through the TBC system 56 and into the substrate 50, portions of the TBC system 56 and substrate 50 may be eroded away by the projections 114 and the comb base 116 to define the desired shape of the diffuser holes 14 and the angled trench 12.

Moreover, as indicated above, it should be readily appreciated that the disclosed angled trench 12 and diffuser holes 14 need not be limited to use within turbine buckets and/or turbine components. Rather, the present subject matter may generally be applied within any suitable article having a substrate (e.g., a metallic or non-metallic material) and a coating and/or coating system applied thereon through which a medium (e.g., water, steam, air and/or any other suitable fluid) is directed for cooling a surface of the article and/or for maintaining the temperature of a surface of the article. For instance, the inner surface 52 of the substrate 50 described above with reference to FIG. 3 may generally comprise any suitable surface of an article that is in flow communication with a medium source (e.g., a water source, steam source, air source and/or any other suitable fluid source) such that the medium derived from such source may be directed through the diffuser holes 14 and angled trench 12 and onto a differing surface of the article.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An article comprising:
a substrate having a first surface and a second surface;
a coating disposed on said second surface;
an angled trench defined at least partially in said coating, said angled trench having a bottom surface, a first sidewall and a second sidewall disposed downstream of said first sidewall, said first and second sidewalls extending from said bottom surface at an angle of less than about 60 degrees; and
a plurality of holes defined between said first surface and said bottom surface.

2. The article of claim 1, wherein said first and second sidewalls extend from said bottom surface at an angle of less than about 45 degrees.

3. The article of claim 1, wherein said angle of said first sidewall is the same as or different than said angle of said second side wall.

4. The article of claim 1, wherein said angle of said first sidewall ranges from about 15 degrees to about 45 degrees and said angle of said second sidewall ranges from about 5 degrees to about 35 degrees.

5. The article of claim 1, wherein each of said plurality of holes includes a metering portion and a diffusing portion.

6. The article of claim 5, wherein said metering portion extends between said first surface and said diffusing portion and said diffusing portion extends from said metering portion and diverges outwardly towards said bottom surface.

7. The article of claim 6, wherein said diffusing portion diverges outwardly in a longitudinal direction of said angled trench.

8. A turbine component comprising:
an airfoil including a base and a tip disposed opposite said base, said airfoil being formed from a substrate having a first surface and a second surface;
a thermal barrier coating system disposed on said second surface;
an angled trench defined at least partially in said thermal barrier coating system so as to extend lengthwise at least partially between said base and said tip, said angled trench having a bottom surface, a first sidewall and a second sidewall disposed downstream of said first sidewall, said first and second sidewalls extending from said bottom surface at an angle of less than about 60 degrees; and
a plurality of holes defined between said first surface and said bottom surface.

9. The turbine component of claim 8, wherein said first and second sidewalls extend from said bottom surface at an angle of less than about 45 degrees.

10. The turbine component of claim 8, wherein said angle of said first sidewall is the same as or different than said angle of said second side wall.

11. The turbine component of claim 8, wherein said angle of said first sidewall ranges from about 15 degrees to about 45 degrees and said angle of said second sidewall ranges from about 5 degrees to about 35 degrees.

12. The turbine component of claim 8, wherein each of said plurality of holes includes a metering portion and a diffusing portion.

13. The turbine component of claim 12, wherein said metering portion extends between said first surface and said diffusing portion and said diffusing portion extends from said metering portion and diverges outwardly towards said bottom surface.

14. The turbine component of claim 13, wherein said diffusing portion diverges outwardly in a longitudinal direction of said angled trench.

15. A method for making an article formed from a substrate having a first surface, a second surface and a coating disposed on the second surface, the method comprising:
removing a portion of the coating to form an angled trench, said angled trench having a bottom surface and at least one sidewall extending from said bottom surface at an angle of less than about 60 degrees; and
forming a plurality of holes extending from said bottom surface to the first surface of the substrate.

16. The method of claim 15, wherein removing a portion of the coating to form an angled trench comprises removing a portion of the coating using at least one of a laser machining process, an electrical discharge machining process, a milling process and a water jet machining process to form said angled trench.

17. The method of claim 15, wherein forming a plurality of holes extending from said bottom surface to the first surface of the substrate comprises forming said plurality of holes extending from said bottom surface to the first surface of the substrate using at least one of a laser machining process, an electrical discharge machining process, a milling process and a water jet machining process.

18. The method of claim 15, wherein forming a plurality of holes extending from the first surface of the substrate to said bottom surface comprises:
forming a diffusing portion of said plurality of holes extending from said bottom surface; and
forming a metering portion of said plurality of holes extending from said diffusing portion to the first surface of the substrate.

19. The method of claim 18, wherein forming a diffusing portion of said plurality of holes extending from said bottom surface and forming a metering portion of said plurality of holes extending from said diffusing portion to the first surface of the substrate comprises forming said diffusing portion and said metering portion simultaneously using a shaped electrode or using an electrode comb.

20. The method of claim 16, wherein removing a portion of the coating to form an angled trench and forming a plurality of holes extending from said bottom surface to the first surface of the substrate comprises forming said angled trench and said plurality of holes simultaneously using an electrode comb.
